(19) United States
(12) Patent Application Publication
(10) Pub. No.: US 2021/0256304 A1
(43) Pub. Date: Aug. 19, 2021

(54) METHOD AND APPARATUS FOR TRAINING MACHINE LEARNING MODEL, APPARATUS FOR VIDEO STYLE TRANSFER

(71) Applicant: GUANGDONG OPPO MOBILE TELECOMMUNICATIONS CORP., LTD., Dongguan (CN)

(72) Inventor: Jenhao Hsiao, Palo Alto, CA (US)

(21) Appl. No.: 17/225,660

(22) Filed: Apr. 8, 2021

Related U.S. Application Data
(63) Continuation of application No. PCT/CN2019/104525, filed on Sep. 5, 2019.
(60) Provisional application No. 62/743,941, filed on Oct. 10, 2018.

(51) Int. Cl. G06K 9/62; G06N 3/08; G06N 3/04

(52) U.S. Cl. CPC G06K 9/6232; G06N 3/04; G06N 3/08; G06K 9/627

(57) ABSTRACT

Schemes for training a machine learning model and schemes for video style transfer are provided. In a method for training a machine learning model, at a stylizing network of the machine learning model, an input image and a noise image are received, the noise image is obtained by adding random noise to the input image; at the stylizing network, a stylized input image of the input image and a stylized noise image of the noise image are received respectively; at a loss network coupled with the stylizing network, a plurality of losses of the input image are obtained according to the stylized input image, the stylized noise image, and a predefined target image; the machine learning model is trained according to analyzing of the plurality of losses.

### CROSS-REFERENCE TO RELATED APPLICATION(S)

This application is a continuation-application of International (PCT) Patent Application No. PCT/CN2019/104525 filed on Sep. 5, 2019, which claims priority to U.S. Provisional application No. 62/743,941 filed on Oct. 10, 2018, the entire contents of both of which are hereby incorporated by reference.

### TECHNICAL FIELD

This disclosure relates to image processing and, more specifically, to the training of a machine learning model and a video processing scheme using the trained machine learning model.

### BACKGROUND

The development of communication devices has led to the population of cameras and video devices. The communication device usually takes the form portable integrated computing device such as smart phones or tablets and is typically equipped with a general purpose camera. The integration of cameras into communication has enabled people to share images and videos more frequently than ever before. Users often desire to apply one or more corrective or artistic filters to their images and/or videos before sharing them with others or posting them to websites or social networks. For example, now it is possible for users to apply the style of a particular painting to any image from their smart phone to obtain a stylized image.

Current video style transfer products are mainly based on traditional image style transfer methods, where they apply image-based style transfer techniques to a video frame by frame. However, this traditional image style transfer method based scheme inevitably brings temporal inconsistencies and thus causes severe flicker artifacts.

Meanwhile, video based solution tries to achieve video style transfer directly on the video domain. For example, stable video can be obtained by penalizing departures from the optical flow of the input video, where style features remain present from frame to frame, following the movement of elements in the original video. However, this is computationally far too heavy for real-time style-transfer, taking minutes per frame.

### SUMMARY

Disclosed herein are implementations of machine learning model training and image/video processing, specifically, style transfer.

According to a first aspect of the disclosure, there is provided a method for training a machine learning model. The method is implemented as follows. At a stylizing network of the machine learning model, an input image and a noise image are received, the noise image being obtained by adding random noise to the input image. At the stylizing network, a stylized input image of the input image and a stylized noise image of the noise image are obtained respectively. At a loss network coupled with the stylizing network, a plurality of losses of the input image is obtained according to the stylized input image, the stylized noise image, and a predefined target image. The machine learning model is trained according to analyzing of the plurality of losses.

According to a second aspect of the disclosure, there is provided an apparatus for training a machine learning model. The apparatus is implemented to include a memory and a processor. The memory is configured to store training schemes. The processor is coupled with the memory and configured to execute the training schemes to training the machine learning model. The training schemes are configured to: apply a noise adding function to an input image to obtain a noise image by adding a random noise to the input image; apply a stylizing function to obtain a stylized input image and a stylized noise image from the input image and the noise image respectively; apply a loss calculating function to obtain a plurality of losses of the input image, according to the stylized input image, the stylized noise image, and a predefined target image; apply the loss calculating function to obtain a total loss of the input image, the total loss being configured to be adjusted to achieve a stable video style transfer via the machine learning model.

According to a third aspect of the disclosure, there is provided an apparatus for video style transfer. The apparatus is implemented to include a display device, a memory, and a processor. The display device is configured to display an input video and a stylized input video, the input video being composed of a plurality of frames of input images each containing content features. The memory is configured to store a pre-trained video style transfer scheme implemented to transfer the input video into the stylized input video by performing image style transfer on the input video frame by frame. The processor is configured to execute the pre-trained video style transfer scheme to transfer the input video into the stylized input video. The video style transfer scheme is trained by: applying a stylizing function to obtain a stylized input image and a stylized noise image from an input image and a noise image respectively, the input image is one frame of image of the input video, the noise image is obtained by adding a random noise to the input image; applying a loss calculating function to obtain a plurality of losses of the input image, according to the stylized input image, the stylized noise image, and a predefined target image; applying the loss calculating function to obtain a total loss of the input image, the total loss being configured to be adjusted to achieve a stable video style transfer.

### BRIEF DESCRIPTION OF DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a schematic diagram illustrating an application of image style transfer.

FIG. 2 is a schematic diagram illustrating a video style transfer network according to an embodiment of the disclosure.

FIG. 3 is a schematic diagram illustrating another video style transfer network according to an embodiment of the disclosure.

FIG. 4 is a schematic diagram illustrating a loss network of the video style transfer network of FIG. 3.

FIG. 5 is a flowchart illustrating a method for training a machine learning model according to an embodiment of the disclosure.

FIG. 6 is a schematic diagram illustrating a loss-based training process according to an embodiment of the disclosure.

FIG. 7 is a schematic block diagram illustrating an apparatus for training a machine learning model according to an embodiment of the disclosure.

FIG. 8 illustrates an example where video style transfer is performed using a terminal.

FIG. 9 is a schematic block diagram illustrating an apparatus for video style transfer.

### DETAILED DESCRIPTION

In the following description, for purposes of explanation, numerous specific details are set forth in order to provide a thorough understanding of the disclosure. It will be apparent, however, to one skilled in the art that the disclosure may be practiced without these specific details. In other instances, structures and devices are shown in block diagram form in order to avoid obscuring the disclosure. References in the specification to “one embodiment” or “an embodiment” means that a particular feature, structure, or characteristic described in connection with the embodiments is included in at least one embodiment of the disclosure, and multiple reference to “one embodiment” or “an embodiment” should not be understood as necessarily all referring to the same embodiment.

One class of deep neural networks (DNN) that have been widely used in image processing tasks is a convolutional neural network (CNN), which works by detecting features at larger and larger scales within an image and using non-linear combinations of these feature detections to recognize objects. CNN consists of layers of small computational units that process visual information in a hierarchical fashion, for example, often represented in the form of “layers”. The output of a given layer consists of “feature maps”, i.e., differently-filtered versions of the input image, where “feature map” is a function that takes feature vectors in one space and transforms them into feature vectors in another. The information each layer contains about the input image can be directly visualized by reconstructing the image only from the feature maps in that layer. Higher layers in the network capture the high-level “content” in terms of objects and their arrangement in the input image but do not constrain the exact pixel values of the reconstruction.

Because the representations of the content and the representations of the style of an image can be independently separated via the use of the CNN, see A Neural Algorithm of Artistic Style (Gatys, Ecker, and Bethge, 2015), both representations may also be manipulated independently to produce new and interesting (and perceptually meaningful) images. For example, new “stylized” versions of images (i.e., the “stylized or mixed image”) may be synthesized by combining the content representation of the original image (i.e., the “content image” or “input image”) and the style representation of another image that serves as the source style inspiration (i.e., the “style image”). Effectively, this synthesizes a new version of the content image in the style of the style image, such that the appearance of the synthesized image resembles the style image stylistically, even though it shows generally the same content as the content image.

In some embodiments, a method for training a machine learning model may include: receiving, at a stylizing network of the machine learning model, an input image and a noise image, the noise image being obtained by adding random noise to the input image; obtaining, at the stylizing network, a stylized input image of the input image and a stylized noise image of the noise image respectively; obtaining, at a loss network coupled with the stylizing network, a plurality of losses of the input image according to the stylized input image, the stylized noise image, and a predefined target image; and training the machine learning model according to analyzing of the plurality of losses.

In some embodiments, the loss network may include a plurality of convolution layers to produce feature maps.

In some embodiments, the obtaining, at a loss network coupled with the stylizing network, a plurality of losses of the input image may include: obtaining a feature representation loss representing feature difference between the feature map of the stylized input image and the feature map of the predefined target image; obtaining a style representation loss representing style difference between a Gram matrix of the stylized input image and a Gram matrix of the predefined target image; obtaining a stability loss representing stability difference between the stylized input image and the stylized noise image; and obtaining a total loss according to the feature representation loss, the style representation loss, and the stability loss.

In some embodiments, the stability loss may be defined as an Euclidean distance between the stylized input image and the stylized noise image.

In some embodiments, the feature representation loss at a convolution layer of the loss network may be a squared and normalized Euclidean distance between a feature map of the stylized input image at the convolution layer of the loss network and a feature map of the predefined target image at the convolution layer of the loss network.

In some embodiments, the style representation loss may be a squared Frobenius norm of the difference between the Gram matrix of the feature map of the stylized input image and the Gram matrix of the feature map of the predefined target image.

In some embodiments, the total loss may be defined as a weighted sum of the feature representation loss, the style representation loss and the stability loss, each of the feature representation loss, the style representation loss and the stability loss is applied a respective adjustable weighting parameter.

In some embodiments, the training the machine learning model according to analyzing of the plurality of losses may include: minimizing the total loss by adjusting the weighting parameters to train the stylizing network.

In some embodiments, an apparatus for training a machine learning model may include a memory and a processor. The memory may be configured to store training schemes. The processor may be coupled with the memory and configured to execute the training schemes to training the machine learning model. The training schemes may be configured to: apply a noise adding function to an input image to obtain a noise image by adding a random noise to the input image; apply a stylizing function to obtain a stylized input image and a stylized noise image from the input image and the noise image respectively; apply a loss calculating function to obtain a plurality of losses of the input image, according to the stylized input image, the stylized noise image, and a predefined target image; and apply the loss calculating function to obtain a total loss of the input image. The total loss may be configured to be adjusted to achieve a stable video style transfer via the machine learning model.

In some embodiments, the loss calculating function may be implemented to: compute a feature map of the stylized noise image; compute a feature map of the stylized input image; and compute a squared and normalized Euclidean distance between the feature map of the stylized noise image and the feature map of the stylized input image as a stability loss of the input image.

In some embodiments, the loss calculating function may be implemented to: compute a feature map of the predetermined target image; and compute a squared and normalized Euclidean distance between the feature map of the stylized input image and the feature map of the predetermined target image as a feature representation loss of the input image.

In some embodiments, the loss calculating function may be implemented to: compute a Gram matrix of the feature map of the stylized input image; compute a Gram matrix of the feature map of the predefined target image; and compute a squared Frobenius norm of the Gram matrix of the feature map of the stylized input image and the Gram matrix of the feature map of the predefined target image as a style representation loss of the input image.

In some embodiments, the loss calculating function may be implemented to: compute a total loss by applying weighting parameters to the feature representation loss, the style representation loss, and the stability loss respectively and sum the weighted feature representation loss, the weighted style representation loss, and the weighted stability loss.

In some embodiments, the training schemes may be further configured to minimize the total loss by adjusting the weighting parameters to train the stylizing function.

In some embodiments, an apparatus for video style transfer may include a display device, a memory, and a processor. The display device may be configured to display an input video and a stylized input video. The input video may be composed of a plurality of frames of images. The memory may be configured to store a pre-trained video style transfer scheme implemented to transfer the input video into the stylized input video by performing image style transfer on the input video frame by frame. The processor may be configured to execute the pre-trained video style transfer scheme to transfer the input video into the stylized input video. The video style transfer scheme may be trained by: applying a stylizing function to obtain a stylized input image and a stylized noise image from an input image and a noise image respectively, the input image being one frame of image of the input video the noise image being obtained by adding a random noise to the input image; applying a loss calculating function to obtain a plurality of losses of the input image, according to the stylized input image, the stylized noise image, and a predefined target image; and applying the loss calculating function to obtain a total loss of the input image. The total loss may be configured to be adjusted to achieve a stable video style transfer.

In some embodiments, the loss calculating function may be implemented to: compute a feature map of the stylized noise image; compute a feature map of the stylized input image; and compute a squared and normalized Euclidean distance between the feature map of the stylized noise image and the feature map of the stylized input image as a stability loss of the input image.

In some embodiments, the loss calculating function may be implemented to: compute a feature map of the predetermined target image; and compute a squared and normalized Euclidean distance between the feature map of the stylized input image and the feature map of the predetermined target image as a feature representation loss of the input image.

In some embodiments, the loss calculating function may be implemented to: compute a Gram matrix of the feature map of the stylized input image; compute a Gram matrix of the feature map of the predefined target image; and compute a squared Frobenius norm of the Gram matrix of the feature map of the stylized input image and the Gram matrix of the feature map of the predefined target image as a style representation loss of the input image.

In some embodiments, the loss calculating function may be implemented to compute a total loss by calculating a weighted sum of the weighted feature representation loss, the style representation loss, and the stability loss.

In some embodiments, the apparatus may further include a video system. The video system may be configured to parse the input video into the plurality frames of images and synthesis a plurality of stylized input images into the stylized input video.

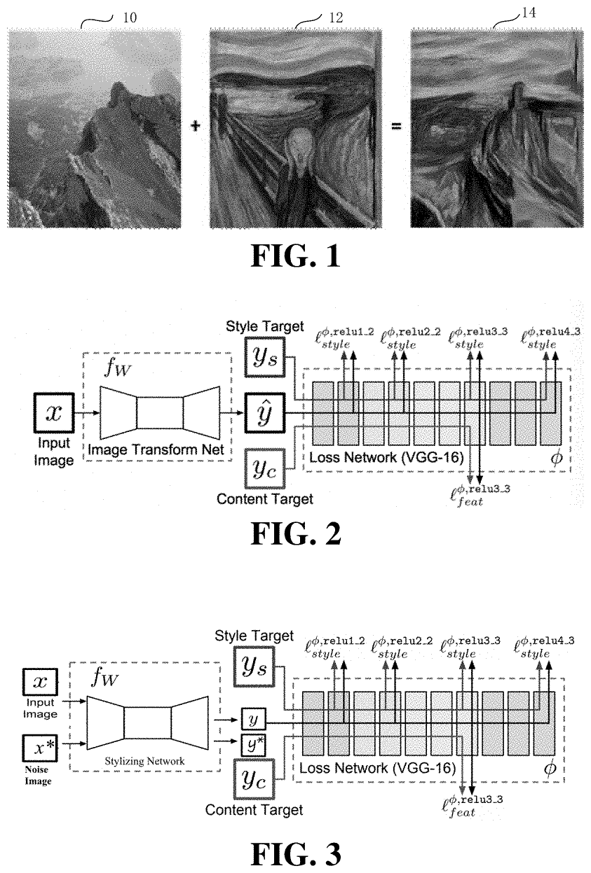

Referring now to FIG. 1, an example of an application of image style transfer is shown, according to an embodiment of the disclosure. In this example, image 10 servers as the content image, image 12 servers as the style image from which the style will be extracted and then applied to the content image 10 to create a stylized version of the content image, that is, image 14. For video style transfer, it can be understood as a series of image style transfer in which image style transfer is applied to a video frame by frame, and image 10 can be one frame of a video.

As can be seen, the stylized image 14 largely retains the same content as the un-stylized version, that is, content image 10. For example, the stylized image 14 retains the basis layout, shape, and size of the main elements of the content image 10, such as the mountain and the sky. However, various elements extracted from the style image 12 are perceivable in the stylized image 14. For example, the texture of the style image 12 was applied to the stylized image 14, while the shape of the mountain has been modified slightly. As is to be understood, the stylized image 14 of the content image 10 illustrated in FIG. 1 is merely exemplary of the types of style representations that may be extracted from the style image and applied to the content image.

Now there has proposed an image style transfer scheme which is achieved via model-based iteration, where the style to be applied to the content image is specified, so as to generate the stylized image by converting the input image directly to the stylized image with a specific texture style based on contents of the input content image. FIG. 2 is a schematic diagram illustrating an image style transfer CNN network. As illustrated in FIG. 2, an image transformation network is trained to transform an input image(s) into an output image(s). A loss network is pre-trained for image classification to define perceptual loss functions that measure perceptual differences in content and style between images. The loss network remains fixed during the training process.

When using the CNN network illustrated in FIG. 2 for video style transfer, temporal instability and popping result from the style changing radically when the input changes very little. In fact, the changes in pixel values from frame-to-frame are mostly noise. Taking this into consideration, we impose a new loss, called stability loss, to simulate this flicker effect (i.e., caused by noise) and then reduce it. The stabilization is done at training time, allowing for an unruffled style transfer of videos in real-time.

FIG. 3 illustrates architecture of the proposed CNN network. As illustrated in FIG. 3, this CNN system is composed of a stylizing network (fw) and a loss network, which will be detailed below in detail respectively.

The stylizing network is trained to transform input images to output images. As mentioned before, in case of video style transfer, the input image can be deemed as one frame of image of the video to be transferred. With the architecture of FIG. 3, an original image (that is, the input image x) and a noise image (x*), which is obtained by manually adding a small amount of noise to the input image, are input to the stylizing network. Based on the input image x and the noise image x* received, the stylizing network can generate stylized images y and y*, here, the stylized images are named as stylized content mage y and stylized noise image y* respectively, where y is the stylized image of x and y* is the stylized image of y, and they will then be input to the loss network.

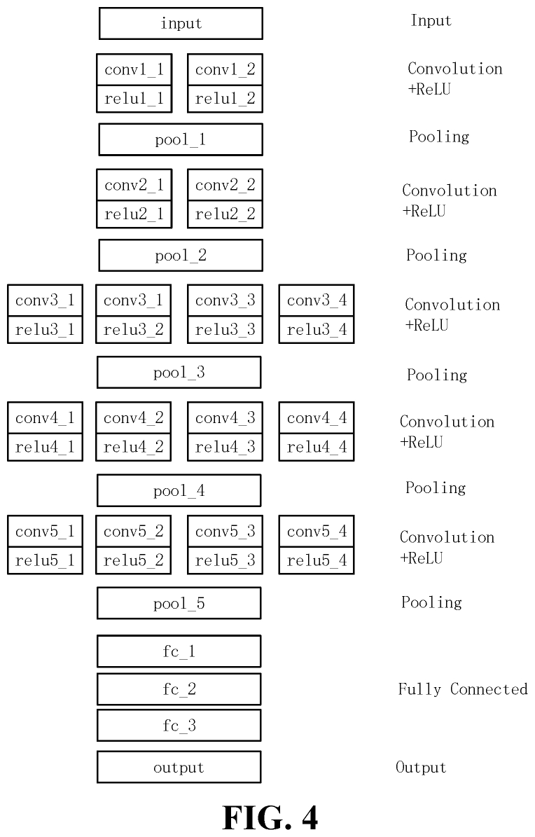

The stylizing network is a deep residual convolutional neural network parameterized by a weight W; it converts the input image or multiple input images x into an output image or output images y via a mapping y=fw(x). Similarly, it converts the noise image y into an output noise image y* via a mapping y*=*(x*).Where fw( ) is the stylizing network (illustrated in FIG. 4) and represents a mapping between input images and output images. As one implementation, both the input image and the output image can be color pictures of 3*256*256. The following Table 1 illustrates architecture of the stylizing network. Referring to FIG. 3 and Table 1, the stylizing network consists of an encoder, bottleneck modules, and a decoder. The encoder is configured for general image construction. The decoder is symmetrical to the encoder and conducts up-sampling layers to enlarge the spatial resolutions of feature maps. A sequence of operations used in the bottleneck module (projection, convolution, projection) can be seen as decomposing one large convolution layer into a series of smaller and simpler operations.

TABLE 1

| Part | Input Shape | Operation | Output Shape |
|---|---|---|---|
| encoder | (h, w, n_{c}) | CONV-(C64, K7 × 7, S1 × 1, Pₛₐₘₑ), ReLU, Instance Normal | (h, w, 64) |
| | (h, w, 64) | CONV-(C128, K4 × 4, S2 × 2, Pₛₐₘₑ), ReLU, Instance Normal | $( \frac{h}{2} , \frac{w}{2} , 128 )$ |
| | $( \frac{h}{2} , \frac{w}{2} , 128 )$ | CONV-(C256, K4 × 4, S2 × 2, Pₛₐₘₑ), ReLU, Instance Normal | $( \frac{h}{4} , \frac{w}{4} , 256 )$ |
| bottleneck | $( \frac{h}{8} , \frac{w}{8} , 256 )$ | Residual Block:CONV-(C256, K3 × 3, S1 × 1, Pₛₐₘₑ), ReLU, Instance Normal | $( \frac{h}{8} , \frac{w}{8} , 256 )$ |
| | $( \frac{h}{8} , \frac{w}{8} , 256 )$ | Residual Block:CONV-(C256, K3 × 3, S1 × 1, Pₛₐₘₑ), ReLU, Instance Normal | $( \frac{h}{8} , \frac{w}{8} , 256 )$ |
| | $( \frac{h}{8} , \frac{w}{8} , 256 )$ | Residual Block:CONV-(C256, K3 × 3, S1 × 1, Pₛₐₘₑ), ReLU, Instance Normal | $( \frac{h}{8} , \frac{w}{8} , 256 )$ |
| | $( \frac{h}{8} , \frac{w}{8} , 256 )$ | Residual Block:CONV-(C256, K3 × 3, S1 × 1, Pₛₐₘₑ), ReLU, Instance Normal | $( \frac{h}{8} , \frac{w}{8} , 256 )$ |
| | $( \frac{h}{8} , \frac{w}{8} , 256 )$ | Residual Block:CONV-(C256, K3 × 3, S1 × 1, Pₛₐₘₑ), ReLU, Instance Normal | $( \frac{h}{8} , \frac{w}{8} , 256 )$ |
| | $( \frac{h}{8} , \frac{w}{8} , 256 )$ | Residual Block:CONV-(C256, K3 × 3, S1 × 1, Pₛₐₘₑ), ReLU, Instance Normal | $( \frac{h}{8} , \frac{w}{8} , 256 )$ |
| docoder | $( \frac{h}{4} , \frac{w}{4} , 256 )$ | DECONV-(C128, K4 × 4, S2 × 2, Pₛₐₘₑ), ReLU, Instance Normal | $( \frac{h}{2} , \frac{w}{2} , 128 )$ |
| | $( \frac{h}{2} , \frac{w}{2} , 128 )$ | DECONV-(C64, K4 × 4, S2 × 2, Pₛₐₘₑ), ReLU, Instance Normal | (h, w, 64) |
| | (h, w, 64) | CONCAT | (h, w, 64 + 3) |
| | (h, w, 64 + 3) | CONV-(C(n_{c}), K7 × 7, S1 × 1, Pₛₐₘₑ) | (h, w, n_{c}) |

For each input image, we have a content goal (that is, content target y_{c} illustrated in FIG. 3) and a style goal (that is, style target yₛ illustrated in FIG. 3). We train a loss network for each target style.

The loss network is pre-trained to extract the features of different input images and computes the corresponding losses, which are then leveraged for training the stylizing network. Specifically, the loss network is pre-trained for image classification to define perceptual loss functions that measure perceptual differences in content, style, and stability between images. The loss network used herein can be a visual geometry group network (VGG), which has been trained to be extremely effective at object recognition, and here we use the VGG-16 or VGG-19 as a basis for trying to extract content and style representations from images.

FIG. 4 illustrates architecture of the loss network VGG. As illustrated in FIG. 4, the VGG consists of 16 layers of convolution and ReLU non-linearity, separated by 5 pooling layers and ending in 3 fully connected layers. The main building blocks of convolutional neural networks are the convolution layers. This is where a set of feature detectors are applied to an image to produce a feature map, which is essentially a filtered version of the image. The feature maps in the convolution layers of the network can be seen as the network's internal representation of the image content. The input layer is configured to parse an image into a multidimensional matrix represented by pixel values. Pooling, also known as sub-sampling or down-sampling, is mainly used to reduce the dimension of features while improving model fault tolerance. After several convolutions, linear correction via the ReLU, and pooling, the model will connect the learned high level features to a fully connected layer to be output.

We hope that features of the stylized image at higher layers of the loss network are consistent with the original image as much as possible (keeping the content and structure of the original image), while the features of the stylized image at lower layers are consistent with the style image as much as possible (retaining the color and texture of the style image). In this way, through continuous training, our network can simultaneously take into account the above two requirements, thus achieving the image style transfer.

To describe it simply, with aid of the proposed CNN network illustrated in FIG. 3, we first pass the input image and the noise image through the VGG network to calculate the style, content, and stability loss. We then send this error back to allow us to determine the gradient of the loss function with respect to the input image. We can then make a small update to the input image and the noise image in the negative direction of the gradient which will cause our loss function to decrease in value (gradient descent). We repeat this process until the loss function is below a desired threshold.

Thus, performing the task of style transfer can be reduced to the task of trying to generate an image which minimizes the loss function, that is, minimizes the content loss, the style loss, and the stability loss, which will be detailed below respectively. The following aspects of the disclosure contribute to its advantages, and each will be described in detail below.

Training Stage

Embodiments of the disclosure provide a method for training a machine learning model. The machine learning model can be the model illustrated in FIG. 3 in combination of FIG. 4. A trained machine learning model can be used for video style transfer as well as image style transfer in testing stage. The machine learning model includes a stylizing network and a loss network coupled to the stylizing network as illustrated in FIG. 3. As mentioned above, the loss network includes multiple convolution layers to produce feature maps.

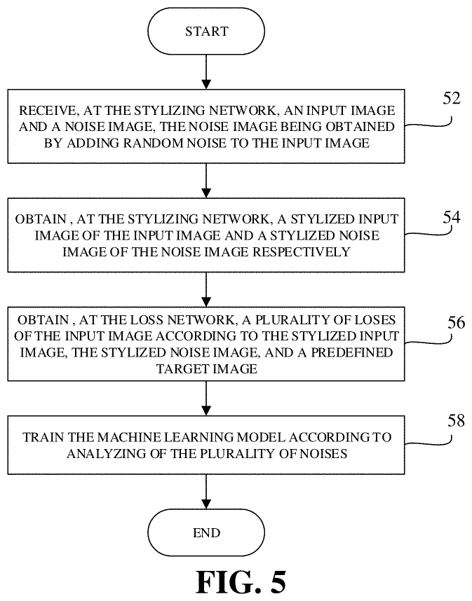

FIG. 5 is a flowchart illustrating the training method. As illustrated in FIG. 5, the training can be implemented to receive (block 52), at the stylizing network, an input image and a noise image, the noise image being obtained by adding random noise to the input image, to obtain (block 54), at the stylizing network, a stylized input image of the input image and a stylized noise image of the noise image respectively, to obtain (block 56), at the loss network, a plurality of losses of the input image according to the stylized input image, the stylized noise image, and a predefined target image, and to train (block 58), the machine learning model according to analyzing of the plurality of losses. The input image can be one frame of image of a video for example.

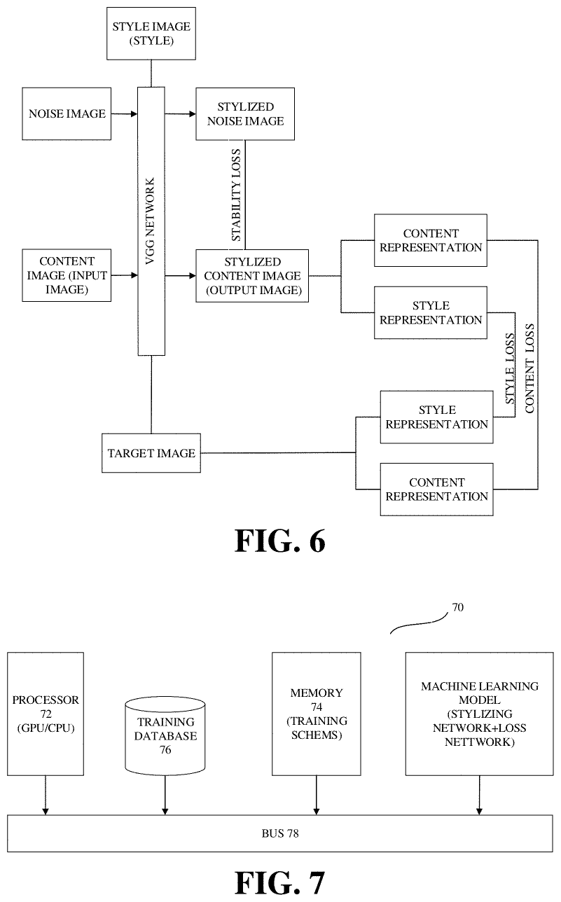

The input image, that is, the content image, can be represented as x, and the stylized input image can be represented as y=fw(x). The noise image can be represented as x*=x+random_noise, and similar as the stylized input image, the stylized noise image can be represented as y*=fw(x*). To better understand the training process, reference is made to FIG. 6, which illustrates the images and losses that may be involved in the training. As can be seen from FIG. 6, the input image and the noise image are input into the VGG network and an output image and a stylized noise image are generated correspondingly. The content loss between the output image and the target image, the style loss between the output image and the target image, and the stability loss between the output image and the stylized noise image are obtained to train the VGG network.

Various losses obtained at the loss network will be described below in detail.

Content Loss (Feature Representation Loss)

As illustrated in FIG. 6, the feature representation loss represents feature difference between the feature map of the stylized input image and the feature map of the predefined target image (content target y_{c} in FIG. 3). Specifically, the feature representation loss can be expressed as the (squared, normalized) Euclidean distance between feature representations and is used to indicate the difference of contents and structure between the input image and the stylized image. The feature representation loss can be obtained as follows.

$${ℓ}_{feat}^{ϕ , j} ( y , {y}_{c} ) = \frac{1}{{C}_{j} {H}_{j} {W}_{j}} {‖ {ϕ}_{j} ( y ) - {ϕ}_{j} ( {y}_{c} ) ‖}_{2}^{2}$$

As can be seen, rather than encouraging the pixels of the stylized image (that is, output image) y=fw (x) to exactly match the pixels of the target image y_{c}, we instead encourage them to have similar feature representations as computed by the loss network φ. This is, rather than calculating the difference between each pixel of the output image and each pixel of the target image, we calculate the difference in similar features by the pre-trained loss network.

φⱼ(*) represents the feature map output at the j^{th} convolution layer of the loss network such as VGG-16, specifically, φⱼ(y) represents the feature map of the stylized input image at the j^{th} convolution layer of the loss network; φⱼ(y_{c}) represents the feature map of the predefined target image at the j^{th} convolution layer of the loss network. Let φⱼ (x) be the activations of the j^{th} convolution layer of the loss network (as illustrated in FIG. 4), where φⱼ (x) will be a feature map of shape Cⱼ×Hⱼ×Wⱼ, where j represents the j^{th} convolution layer; Cⱼ represents the number of channels input into the j^{th} convolution layer; Hⱼ represents the height of the j^{th} convolution layer; and Wⱼ represents the width of the j^{th} convolution layer. As mentioned above, the feature representation loss L_{feat} at the j^{th} convolution layer of the loss network φ may be a squared Euclidean distance between the feature map of the stylized input image y at the j^{th} convolutional layer of the loss network φ and the feature map of the predefined target image y_{c} at the j^{th} convolutional layer of the loss network φ. The feature representation loss L_{feat} at a j^{th} convolution layer of the loss network φ may be further normalized with respect to the size of the feature map at the j^{th} convolutional layer. It is desired that the features of the original image in the j^{th} layer in the loss network should be as consistent as possible with the features of the stylized image in the j^{th} layer.

Feature representation loss penalizes the content deviation of the output image from the target image. We also want to penalize the deviation in terms of style, such as color, texture and mode. In order to achieve this effect, a style representation loss is introduced.

Style Loss (Style Representation Loss)

Extraction of style reconstruction can be done by calculating the Gram matrix of a feature map. The Gram matrix is configured to calculate the inner product of a feature map(s) of one channel and a feature map(s) of another channel, and each value represents a the degree of cross-correlation. Specifically, as illustrated in FIG. 6, the style representation loss measures the difference between the style of the output image and the style of target image, and is calculated as a squared Frobenius norm of the difference between the Gram matrix of the feature map of the stylized input image and the Gram matrix of the feature map of the predefined target image.

First, we use Gram-matrix to measure which features in the style-layers activate simultaneously for the style image, and then copy this activation-pattern to the stylized-image.

Let φⱼ (x) be the activations at the j^{th} layer of the loss network φ for the input image x, which is a feature map of shape Cⱼ×Hⱼ×Wⱼ. The Gram matrix of the j^{th} layer of the loss network φ can be defined as:

$${{G}_{j}^{ϕ} ( x )}_{c , {c}^{′}} = \frac{1}{{C}_{j} {H}_{j} {W}_{j}} {\sum }_{h = 1}^{{H}_{j}} {\sum }_{w = 1}^{{W}_{j}} {{ϕ}_{j} ( x )}_{h , w , c} {{ϕ}_{j} ( x )}_{h , w , {c}^{′}}$$

Where c represents the number of channels output at the j^{th} layer, that is, the number of feature maps. Therefore, the Gram Matrix is a c×c matrix, and the size thereof is independent of the size of the input image. In other words, the Gram matrix for the activations of the j^{th} layer of the loss network φ may be a normalized inner product of the activations at the j^{th} layer of the loss network φ. Optionally, the Gram matrix for the activations of the j^{th} layer of the loss network φ may be normalized with respect to the size of the feature map at the j^{th} layer of the loss network φ.

The style representation loss is the squared Frobenius norm of the difference between the Gram matrices of the output image and the target image.

[symbol]

_{style}^{ϕ,j}( [symbol] , [symbol] _{c})=∥Gⱼ^{φ}( [symbol] )−Gⱼ^{φ}( [symbol] _{c})∥_{hu 2}

Gⱼ^{φ}( [symbol] ) is the Gram-matrix of the output image and Gⱼ^{φ}( [symbol] _{c}) is the Gram-matrix of the target image.

If the feature map is a matrix F, then each entry in the Gram matrix G can be given by

$${G}_{ij} {\sum }_{k} {F}_{ik} {R}_{jk} .$$

As with the content representation, if we had two images, such as the output image y and the target image y_{c}, whose feature maps at a given layer produced the same Gram matrix, we would expect both images to have the same style, but not necessarily the same content. Applying this to early layers in the network would capture some of the finer textures contained within the image whereas applying this to deeper layers would capture more higher-level elements of the image's style.

Stability Loss

As mentioned before, temporal instability and the changes in pixel values from frame-to-frame are mostly noises. We here impose a specific loss at training time: by manually adding a small amount of noise to our images during training and minimizing the difference between the stylized versions of our original image and noisy image, we can train a network for more stable style-transfer.

To be more specific, a noise image x* can be generated by adding some random noise into the content image x. The noisy image then goes through the same stylizing network to get a stylized noisy image y*:

x*=x+random_noise

y*=fw(x*)

For example, each pixel in the original image x is add a Bernoulli noise with the value from (−50, +50). As illustrated in FIG. 6, the stability loss can then be defined as:

L_{stable}=∥y*−y∥2

That is, the stability loss may be the Euclidean distance between the stylized input image y and the stylized noise image y*. Skills in the art would appreciate that, the stability loss may be other kinds of suitable distance.

Total Loss

The total loss can then be written as a weighted sum of the content loss, the style loss, and the stability loss. Each of the content loss, the style loss and the stability loss may be applied a respective adjustable weighting parameter. The final training objective of the propose method is defined as:

L=α L_{feat}+β L_{style}+γL_{stable}

Where α, β, and γ are the weighting parameters and can be adjusted to preserve more of the style or more of the content under the promise of stable video style transfer. Stochastic gradient descent is used to minimize the loss function L to achieve the stable video style transfer. From another point of view, performing the task of image style transfer can now be reduced to the task of trying to generate an image which minimizes the total loss function.

It should be noted that the foregoing formulas illustrated examples of the calculation of the content loss, the style loss, and the stability loss, and the calculation is not limited to the examples. According to actual needs or with technological development, other methods are also be used.

When techniques provided herein are applied to video style transfer, since the newly proposed loss enforce the network to generate video frames that considers temporal consistency, the resulted video will have less flicking than traditional methods.

Traditional method such as Ruder uses optical flow to maintain the temporal consistency, which has heavy computational loading (in order to get the optical flow information). In contrast, our method just introduces minor computation effort (i.e., random noise) during training and has no extra computation effort during testing.

With the method for training a machine learning model described above, a machine learning model for video style transfer can be trained and planted into a terminal to achieve image/video style transfer in the actual use of the user.

Continuing, according to embodiments of the disclosure, an apparatus for training a machine learning model is further provided, which can be adopted to implement the forgoing training method.

FIG. 7 is a block diagram illustrating an apparatus 70. The machine learning model being trained can be the model illustrated in FIG. 3 and FIG. 4, and can be used as a video processing model for image/video style transfer. As illustrated in FIG. 7, generally, the apparatus 70 for training a machine learning model includes a processor 72 and a memory 74 coupled with the processor 72 via a bus 78. The processor 72 can be a graphics processing unit (GPU) or a central processing unit (CPU). The memory 74 is configured to store training schemes, that is, training algorithms, which can be implemented as a computer readable instruction or which can exist on the terminal in the form of an application.

The training schemes, when executed by the processor 72, are configured to apply training related functions to achieve a series of image transfer and matrix calculation, so as to achieve video transfer finally. For example, when executed by the processor, the training schemes are configured to: apply a noise adding function to an input image to obtain a noise image by adding a random noise to the input image; apply a stylizing function to obtain a stylized input image and a stylized noise image from the input image and the noise image respectively; apply a loss calculating function to obtain multiple losses of the input image, according to the stylized input image, the stylized noise image, and a predefined target image; apply the loss calculating function to obtain a total loss of the input image, the total loss being configured to be adjusted to achieve a stable video style transfer via the machine learning model.

By applying the noise adding function, a noise image x* can be generated based on the input image x, where x*=x+random_noise. By applying the stylizing function, an output image y and a stylized noise image y* can be obtained respectively from the input image and the noise image, where y=fw(x), and y*=fw(x*), fw( ) is the stylizing network (illustrated in FIG. 4) and represents a mapping between the input image and the output image as well as the mapping between the noise image and the stylized noise image.

By applying the loss calculating function, multiple losses including the foregoing content loss, style loss, and stability loss can be obtained via the formulas given above. Continuing, by further applying the loss calculating function, the total loss defined as a weighted sum of the three kinds of losses can be obtained, the weighting parameters used to calculate the total loss can be adjusted to obtain a minimum total loss, so as to achieve stable video style transfer.

As one implementation, as illustrated in FIG. 7, the apparatus 70 may further include a training database 76 or training dataset, which contains training records of the machine learning model, the records can be leveraged for training the stylizing network of the machine learning model for example. The training records may contain correspondence relationship between input images, output image, target images, and corresponding losses, and the like.

Testing Stage

With the machine learning model for video style transfer trained, image style transfer as well as video style transfer can be implemented on terminals. The trained machine learning model can be embodied as a video style transfer application installed on a terminal, or can be embodied as module executed on the terminal, for example. The video style transfer application is supported and controlled by video style transfer algorithms, that is, the foregoing video style transfer schemes. The terminal mentioned herein refers to an electronic and computing device, such as any type of client device, desktop computers, laptop computers, mobile phones, table computers, communication, entertainment, gaming, media playback devices, multimedia devices, and other similar devices. These types of computing devices are utilized for many different computer applications in addition to the image processing application, such as graphic design, digital photo image enhancement and the like.

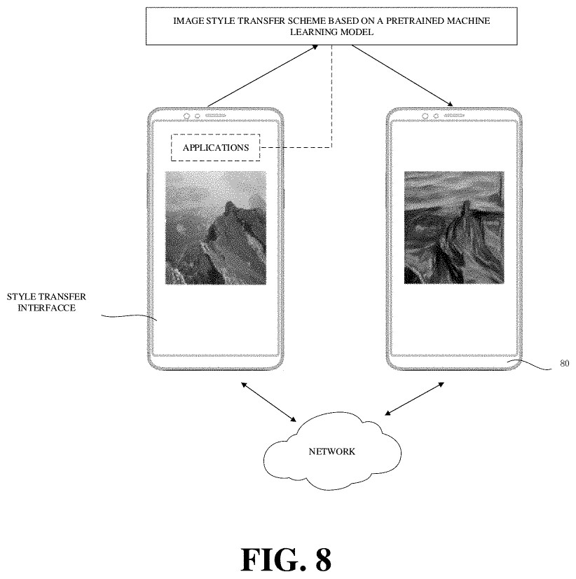

FIG. 8 illustrates an example of video style transfer implemented with a terminal according to an embodiment of the disclosure.

As illustrated in FIG. 8, for example, once the video style transfer application is launched, the terminal 80 can display an style transfer interface, through which the user can select the input video that he or she wants to be transferred (such as the video displayed on the display on the left side of FIG. 8) and/or the style desired, for example, with his or her finger, to implement video style transfer, then via the video style transfer application, a new stylized video (such as the video displayed on the display on the right side of FIG. 8) can be obtained, whose style is equal to the style image (that is, one or more styles selected by the user or specified by the terminal) and whose content is equal to the input video.

According to the video style transfer algorithm, a selection of the input video is received, for example, when the input video is selected by the user. The input video is composed of multiple frames of images each containing content features. Similarly, the video style transfer algorithm can receive a selection of a style image that contains style features or can determine a specified type determined in advance. The video style transfer algorithm then can generate a stylized input video of the input video by applying image style transfer to the video frame by frame; with the image style transfer, an output image is generated based on an input image (that is, one frame of image of the input video) and the style or style image. During training stage, the video style transfer algorithm is pre-trained by: applying a stylizing function to obtain a stylized input image and a stylized noise image from an input image and a noise image respectively, the input image is one frame of image of the input video, the noise image is obtained by adding a random noise to the input image; applying a loss calculating function to obtain a plurality of losses of the input image, according to the stylized input image, the stylized noise image, and a predefined target image; and applying the loss calculating function to obtain a total loss of the input image, the total loss being configured to be adjusted to achieve a stable video style transfer.

Where the loss calculating function is implemented to: compute a feature map of the stylized noise image, compute a feature map of the stylized input image, and compute a squared and normalized Euclidean distance between the feature map of the stylized noise image and the feature map of the stylized input image as a stability loss of the input image.

Where the loss calculating function is further implemented to: compute a feature map of the stylized input image, compute a feature map of the predetermined target image, and compute a squared and normalized Euclidean distance between the feature map of the stylized input image and the feature map of the predetermined target image as a feature representation loss of the input image.

Where the loss calculating function is further implemented to: compute a Gram matrix of the feature map of the stylized input image, compute a Gram matrix of the feature map of the predefined target image, and compute a squared Frobenius norm of the Gram matrix of the feature map of the stylized input image and the Gram matrix of the feature map of the predefined target image as a style representation loss of the input image.

Where the loss calculating function is further implemented to: compute a total loss by calculating a weighted sum of the weighted feature representation loss, the style representation loss, and the stability loss.

Details of the loss computing can be understood in conjunction with the forgoing detailed embodiments and will not be repeated herein.

Since a video is composed of multiple frames of images, when conducting video style transfer, the input image can be one frame image of the video, that is, the stylizing network takes one frame as input; once image style transfer is conducted on the video frame by frame, video style transfer can be completed.

In the above, techniques for machine learning training and video style transfer have been described, however, with the understanding that the principles of the disclosure apply more generally to any image based media, image style transfer can also be achieved with the techniques provided herein.

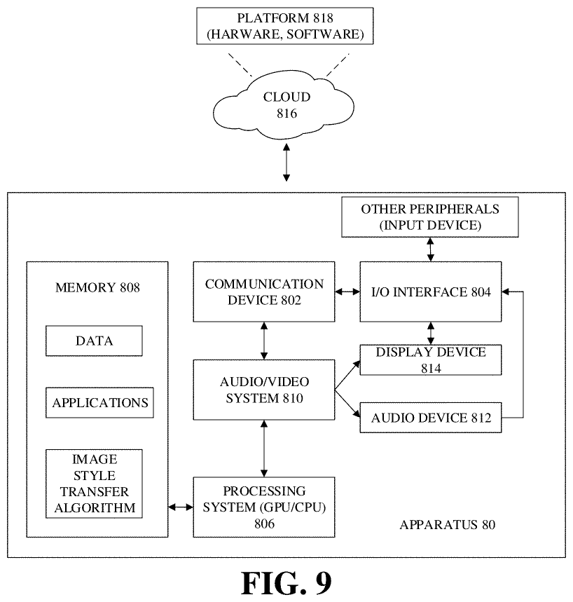

FIG. 9 illustrates an example apparatus 80 for video style transfer to implement the trained machine learning model in the testing stage.

The apparatus 80 includes a communication device 802 that enable wired and/or wireless communication of system data, such as input videos, images, selected style images or selected styles, and resulting stylized videos, images, as well as computing application content that is transferred inside the terminal, transferred from the terminal to another computing device, and/or synched between multiple computing devices. The system data can include any type of audio, video, image, and/or graphic data generated by applications executing on the device. Examples of the communication device 802 include but not limited to bus, communication interface, and the like.

The apparatus 80 further includes input/output (I/O) interfaces 804, such as data network interfaces that provide connection and/or communication links between terminals, systems, networks, and other devices. The I/O interfaces can be used to couple the system to any type of components, peripherals, and/or accessory devices, such as a digital camera device that may be integrated with the terminal or the system. The I/O interfaces also include data input ports via which any type of data, media content, and/or inputs can be received, such as user inputs to the apparatus, as well as any type of audio, video, and/or image data received from any content and/or data source.

The apparatus 80 further includes a processing system 806 that may be implemented at least partially in hardware, such as with any type of microprocessors, controllers, and the like that process executable instructions. In one implementation, the processing system 806 is a GPU/CPU having access to a memory 808 given below. The processing system can include components of integrated circuits, a programmable logic device, a logic device formed using one or more semiconductors, and other implementations in silicon and/or hardware, such as a processor and memory system implemented as a system-on-chip (SoC).

The apparatus 80 also includes the memory 808, which can be computer readable storage medium 808, examples of which includes but limited to data storage devices that can be accessed by a computing device, and that provide persistent storage of data and executable instructions such as software applications, modules, programs, functions, and the like. Examples of computer readable storage medium include volatile medium and non-volatile medium, fixed and removable medium devices, and any suitable memory device or electronic data storage that maintains data for access. The computer readable storage medium can include various implementations of random access memory (RAM), read-only memory (ROM), flash memory, and other types of storage memory in various memory device configurations.

The apparatus 80 also includes an audio and/or video system 810 that generates audio data for audio device 812 and/or generates display data for a display device 814. The audio device and/or the display device include any devices that process, display, and/or otherwise render audio, video, display, and/or image data, such as the content features of an image. For example, the display device can be a LED display and a touch display.

In at least one embodiment, at least part of the techniques described for video style transfer can be implemented in a distributed system, such as in a platform 818 via a cloud system 816. Obviously the cloud system 816 can be implemented as part of the platform 818. The platform 818 abstracts underlying functionality of hardware and/or software device, and connects the apparatus 80 with other devices or servers.

For example, with an input device coupled with the I/O interface 804, a user can input or select an input video or input image (content image) such as video or image 10 of FIG. 1, the input video will be transmitted to the display device 814 via the communication devices 802 to be displayed. The input device can be a keyboard, a mouse, a touch screen and the like. The input video can be selected from any video that is accessible on the terminal, such as a video that has been captured or recorded with a camera device and stored in a photo collection of the memory 808 of the terminal, or a video that is accessible from an external device or storage platform 818 via a network connection or cloud connection 816 with the device. Then a style selected by the user or specified by the terminal 80 by default will be transferred to the input video to stylize the later into the output video via the processing system 806 by invoking the video style transfer algorithms stored in the memory 808. Specifically, the input video received will be sent to the video system 810 to be parsed into multiple frames of images, each of which will undergo image style transfer via the processing system 806. The video style transfer algorithms are implemented to conduct image style transfer on the input video frame by frame. Once all images have undergone the image style transfer frame by frame, the obtained stylized images will be combined by the video system 810 into one stylized video to be presented to the user on the display device 814. After conducting video style transfer with the video style transfer application, an output video such as the video represented as image 14 of FIG. 1 will be displayed for the user on the display device 814.

Still another example, through the input device coupled with the I/O interface 804, the user can selected an image to be processed. The image can be transferred via the communication device 802 to be displayed on the display device 814. Then the processing system 806 can invoke the video style transfer algorithms stored in the memory 808 to transfer the input image into an output image, which will then be provided to the display device 814 to be presented to the user. It should be noted that, although not mentioned every time, internal communication of the terminal can be completed via the communication device 802.

With the novel image/video style transfer method provided herein, we can effectively alleviate the flicker artifacts. In addition, the proposed solutions are computationally-efficient during both training and testing stages, and thus can be implemented in a real-time application. While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for training a machine learning model, comprising:
receiving, at a stylizing network of the machine learning model, an input image and a noise image, the noise image being obtained by adding random noise to the input image;
obtaining, at the stylizing network, a stylized input image of the input image and a stylized noise image of the noise image respectively;
obtaining, at a loss network coupled with the stylizing network, a plurality of losses of the input image according to the stylized input image, the stylized noise image, and a predefined target image; and
training the machine learning model according to analyzing of the plurality of losses.

2. The method as claimed in claim 1, wherein the loss network comprises a plurality of convolution layers to produce feature maps.

3. The method as claimed in claim 2, wherein the obtaining, at the loss network coupled with the stylizing network, the plurality of losses of the input image comprises:
obtaining a feature representation loss representing feature difference between the feature map of the stylized input image and the feature map of the predefined target image;
obtaining a style representation loss representing style difference between a Gram matrix of the stylized input image and a Gram matrix of the predefined target image;
obtaining a stability loss representing stability difference between the stylized input image and the stylized noise image; and
obtaining a total loss according to the feature representation loss, the style representation loss, and the stability loss.

4. The method as claimed in claim 3, wherein the stability loss is defined as an Euclidean distance between the stylized input image and the stylized noise image.

5. The method as claimed in claim 4, wherein the feature representation loss at a convolution layer of the loss network is a squared and normalized Euclidean distance between a feature map of the stylized input image at the convolution layer of the loss network and a feature map of the predefined target image at the convolution layer of the loss network.

6. The method as claimed in claim 5, wherein the style representation loss is a squared Frobenius norm of the difference between the Gram matrix of the feature map of the stylized input image and the Gram matrix of the feature map of the predefined target image.

7. The method as claimed in claim 6, wherein the total loss is defined as a weighted sum of the feature representation loss, the style representation loss and the stability loss, each of the feature representation loss, the style representation loss and the stability loss is applied a respective adjustable weighting parameter.

8. The method as claimed in claim 7, wherein the training the machine learning model according to analyzing of the plurality of losses comprises:
minimizing the total loss by adjusting the weighting parameters to train the stylizing network.

9. An apparatus for training a machine learning model, comprising:
a memory, configured to store training schemes;
a processor, coupled with the memory and configured to execute the training schemes to training the machine learning model, the training schemes being configured to:
apply a noise adding function to an input image to obtain a noise image by adding a random noise to the input image;
apply a stylizing function to obtain a stylized input image and a stylized noise image from the input image and the noise image respectively;
apply a loss calculating function to obtain a plurality of losses of the input image, according to the stylized input image, the stylized noise image, and a predefined target image; and
apply the loss calculating function to obtain a total loss of the input image, the total loss being configured to be adjusted to achieve a stable video style transfer via the machine learning model.

10. The apparatus as claimed in claim 9, wherein the loss calculating function is implemented to:
compute a feature map of the stylized noise image;
compute a feature map of the stylized input image; and
compute a squared and normalized Euclidean distance between the feature map of the stylized noise image and the feature map of the stylized input image as a stability loss of the input image.

11. The apparatus as claimed in claim 10, wherein the loss calculating function is implemented to:
compute a feature map of the predefined target image; and
compute a squared and normalized Euclidean distance between the feature map of the stylized input image and the feature map of the predefined target image as a feature representation loss of the input image.

12. The apparatus as claimed in claim 11, wherein the loss calculating function is implemented to:
compute a Gram matrix of the feature map of the stylized input image;
compute a Gram matrix of the feature map of the predefined target image; and
compute a squared Frobenius norm of the Gram matrix of the feature map of the stylized input image and the Gram matrix of the feature map of the predefined target image as a style representation loss of the input image.

13. The apparatus as claimed in claim 12, wherein the loss calculating function is implemented to:
compute a total loss by applying weighting parameters to the feature representation loss, the style representation loss, and the stability loss respectively and summing the weighted feature representation loss, the weighted style representation loss, and the weighted stability loss.

14. The apparatus as claimed in claim 13, wherein the training schemes is further configured to minimize the total loss by adjusting the weighting parameters to train the stylizing function.

15. An apparatus for video style transfer, comprising:
a display device, configured to display an input video and a stylized input video, the input video being composed of a plurality of frames of images;
a memory, configured to store a pre-trained video style transfer scheme implemented to transfer the input video into the stylized input video by performing image style transfer on the input video frame by frame; and
a processor, configured to execute the pre-trained video style transfer scheme to transfer the input video into the stylized input video;
the video style transfer scheme is trained by:
applying a stylizing function to obtain a stylized input image and a stylized noise image from an input image and a noise image respectively, the input image being one frame of image of the input video the noise image being obtained by adding a random noise to the input image;
applying a loss calculating function to obtain a plurality of losses of the input image, according to the stylized input image, the stylized noise image, and a predefined target image; and
applying the loss calculating function to obtain a total loss of the input image, the total loss being configured to be adjusted to achieve a stable video style transfer.

16. The apparatus as claimed in claim 15, wherein the loss calculating function is implemented to:
compute a feature map of the stylized noise image;
compute a feature map of the stylized input image; and
compute a squared and normalized Euclidean distance between the feature map of the stylized noise image and the feature map of the stylized input image as a stability loss of the input image.

17. The apparatus as claimed in claim 16, wherein the loss calculating function is implemented to:
compute a feature map of the predefined target image; and
compute a squared and normalized Euclidean distance between the feature map of the stylized input image and the feature map of the predefined target image as a feature representation loss of the input image.

18. The apparatus as claimed in claim 17, wherein the loss calculating function is implemented to:
compute a Gram matrix of the feature map of the stylized input image;
compute a Gram matrix of the feature map of the predefined target image; and
compute a squared Frobenius norm of the Gram matrix of the feature map of the stylized input image and the Gram matrix of the feature map of the predefined target image as a style representation loss of the input image.

19. The apparatus as claimed in claim 18, wherein the loss calculating function is implemented to:
compute a total loss by calculating a weighted sum of the weighted feature representation loss, the style representation loss, and the stability loss.

20. The apparatus as claimed in claim 15, further comprising:
a video system, configured to parse the input video into the plurality frames of images and synthesis a plurality of stylized input images into the stylized input video.
